(19) United States
(12) Patent Application Publication
(10) Pub. No.: US 2022/0105782 A1
(43) Pub. Date: Apr. 7, 2022

(54) CABIN AIR FLUSH

(71) Applicant: WAYMO LL C, Mountain View, CA (US)

(72) Inventors: Chung-ling Lee, Sunnyvale, CA (US); Simon Ellgas, San Jose, CA (US); Philip Nemec, San Jose, CA (US); Cristi Landy, Sunnyvale, CA (US); Anna-Maria Schumacher, San Jose, CA (US)

(21) Appl. No.: 17/492,161

(22) Filed: Oct. 1, 2021

Related U.S. Application Data
(60) Provisional application No. 63/086,889, filed on Oct. 2, 2020.

(51) Int. Cl. B60H 1/00; B60W 60/00; B60W 50/02

(52) U.S. Cl. CPC B60H 1/00849; B60W 50/0205; B60W 60/001; B60H 1/00978

(57) ABSTRACT

A control system for an autonomous vehicle is configured to perform a cabin air flush. The autonomous vehicle includes one or more computing devices in communication with a heating, ventilation, and air conditioning (HVAC) system. The one or more computing devices are configured to determine a first ride performed by the autonomous vehicle has ended; determine that conditions are appropriate for a cabin air flush of a cabin of the vehicle; turn off air recirculation in the cabin to open one or more vents of an HVAC system of the vehicle; turn one or more fans of the HVAC system to a maximum level for a set amount of time; and after the set amount of time has elapsed, cause the one or more vents and the one or more fans to switch to a default state.

### CROSS REFERENCE TO RELATED APPLICATIONS

The present application claims the benefit of U.S. Provisional Application No. 63/086,889, filed Oct. 2, 2020, the entire disclosure of which is incorporated by reference herein.

### BACKGROUND

Autonomous vehicles, such as vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. When operating in autonomous mode, various systems of the vehicle may be operated in between picking up a passenger or good without any person in the vehicle.

### BRIEF SUMMARY

A control system of an autonomous vehicle may be configured to perform a cabin air flush while the vehicle is operating in autonomous mode between rides. Aspects of the disclosure provide for a control system for an autonomous vehicle.

Aspects of the disclosure provide for a control system for an autonomous vehicle. The control system includes one or more computing devices in communication with a heating, ventilation, and air conditioning (HVAC) system. The one or more computing devices are configured to determine a first ride performed by the autonomous vehicle has ended; turn off air recirculation in a cabin of the autonomous vehicle to open one or more vents of the HVAC system of the vehicle; turn one or more fans of the HVAC system to a maximum level for a set amount of time for a cabin air flush; and after the set amount of time has elapsed, cause the one or more vents and the one or more fans to switch to a default state.

In one example, the one or more computing devices are also configured to determine that conditions are appropriate for the cabin air flush. In another example, the maximum level for the one or more fans includes a set fan speed to move a most amount of air through the cabin and a set temperature for air in the cabin. In further examples, the one or more computing devices are also configured to receive a ride request for a second ride, the second ride having a pickup time that is after the set amount of time elapses.

In yet another example, the one or more computing devices are also configured to determine that the cabin air flush in the vehicle has not been completed; reattempt to run the cabin air flush after determining the cabin air flush was not completed; and store in a memory an indication of a failed cabin air flush each time the cabin air flush is not run to completion. In this example, the one or more computing devices are also optionally configured to send a message to a remote system when a maximum number of failed cabin air flushes are stored in the memory. Also in this example, the one or more computing devices are also optionally configured to determine whether to pull the autonomous vehicle from service based on a maximum number of failed cabin air flushes stored in the memory; and cause the autonomous vehicle to drive to a location for going out of service after determining the vehicle should be pulled out from service.

Other aspects of the disclosure provide for a method for running a cabin air flush in a vehicle. The method includes determining, by one or more computing devices, a first ride performed by the vehicle has ended; turning off, by the one or more computing devices, air recirculation in a cabin of the vehicle to open one or more vents of an HVAC system of the vehicle; turning, by the one or more computing devices, one or more fans of the HVAC system to a maximum level for a set amount of time for the cabin air flush; and after the set amount of time has elapsed, causing, by the one or more computing devices, the one or more vents and the one or more fans to switch to a default state.

Further aspects of the disclosure provide for a tangible, non-transitory computer-readable storage medium configured to store instructions. The instructions, when executed by one or more processors, cause the one or more processors to perform a method for running a cabin air flush in a vehicle. The method includes determining a first ride performed by the vehicle has ended; turning off air recirculation in a cabin of the vehicle to open one or more vents of an HVAC system of the vehicle; turning one or more fans of the HVAC system to a maximum level for a set amount of time for the cabin air flush; and after the set amount of time has elapsed, causing the one or more vents and the one or more fans to switch to a default state.

Yet other aspects of the disclosure provide for a fleet management system for a plurality of autonomous vehicles. The fleet management system includes a communication system configured to transmit and receive signals to each of the plurality of autonomous vehicles; and one or more computing devices. The one or more computing devices are configured to receive a message from a given autonomous vehicle in the plurality of autonomous vehicles that a maximum number of cabin air flushes have failed in the given autonomous vehicle; determine to pull the given autonomous vehicle from service based on the maximum number of failed cabin air flushes; and send, using the communication system, instructions to the given autonomous vehicle to drive to a location for going out of service after determining the vehicle should be pulled from service.

Still further aspects of the disclosure provide for a method for managing a fleet of autonomous vehicles. The method includes receiving, by one or more computing devices, a message from a given autonomous vehicle in the fleet of autonomous vehicles that a maximum number of cabin air flushes have failed in the given autonomous vehicle; determining, by the one or more computing devices, to pull the given autonomous vehicle from service based on the maximum number of failed cabin air flushes; and sending, by the one or more computing devices using a communication system, instructions to the given autonomous vehicle to drive to a location for going out of service after determining the vehicle should be pulled from service.

Other aspects of the disclosure provide for a tangible, non-transitory computer-readable storage medium configured to store instructions. The instructions, when executed by one or more processors, cause the one or more processors to perform a method for managing a fleet of autonomous vehicles. The method includes receiving a message from a given autonomous vehicle in the fleet of autonomous vehicles that a maximum number of cabin air flushes have failed in the given autonomous vehicle; determining to pull the given autonomous vehicle from service based on the maximum number of failed cabin air flushes; and sending, using a communication system, instructions to the given autonomous vehicle to drive to a location for going out of service after determining the vehicle should be pulled from service.

Further aspects of the disclosure provide for a fleet management system for a plurality of autonomous vehicles. The fleet management system includes a communication system configured to transmit and receive signals to each of the plurality of autonomous vehicles; and one or more computing devices. The one or more computing devices are configured to receive one or more ride requests from one or more client devices; assign each of the one or more ride requests to an autonomous vehicle in the plurality of autonomous vehicles based on availability of a given vehicle, the availability of the given vehicle factoring in an offline amount of time for a cabin air flush of the given vehicle; and send, using the communication system, the one or more ride requests to each assigned autonomous vehicle.

Yet other aspects of the disclosure provide for a method for managing a fleet of autonomous vehicles. The method includes receiving, by one or more computing devices, one or more ride requests from one or more client devices; assigning, by the one or more computing devices, each of the one or more ride requests to an autonomous vehicle in the fleet of autonomous vehicles based on availability of a given vehicle, the availability of the given vehicle factoring in an offline amount of time for a cabin air flush of the given vehicle; and sending, by the one or more computing devices using a communication system, the one or more ride requests to each assigned autonomous vehicle.

Still further aspects of the disclosure provide for a tangible, non-transitory computer-readable storage medium configured to store instructions. The instructions, when executed by one or more processors, cause the one or more processors to perform a method for managing a fleet of autonomous vehicles. The method includes receiving one or more ride requests from one or more client devices; assigning each of the one or more ride requests to an autonomous vehicle in the fleet of autonomous vehicles based on availability of a given vehicle, the availability of the given vehicle factoring in an offline amount of time for a cabin air flush of the given vehicle; and sending, using a communication system, the one or more ride requests to each assigned autonomous vehicle.

### BRIEF DESCRIPTION OF THE DRAWINGS

FIG. 1 is a functional diagram of an example vehicle in accordance with aspects of the disclosure.

FIG. 2 is an example representation of detailed map information in accordance with aspects of the disclosure.

FIG. 3 is an example external view of a vehicle in accordance with aspects of the disclosure.

FIG. 4 is an example pictorial diagram of a system in accordance with aspects of the disclosure.

FIG. 5 is a functional diagram of the system of FIG. 4 in accordance with aspects of the disclosure.

FIG. 6 is an example flow diagram in accordance with aspects of the disclosure.

FIG. 7 is another example flow diagram in accordance with aspects of the disclosure.

FIG. 8 is a further example flow diagram in accordance with aspects of the disclosure.

### DETAILED DESCRIPTION

### Overview

The technology relates to performing a cabin air flush in between rides in an autonomous vehicle. Odors, germs, or other particulates in the air may be introduced to the air inside the vehicle when passengers or goods are transported in the vehicle for a given ride. The odor, germs, or other particulates may be reduced or removed from the vehicle by performing a cabin air flush before a next ride is performed. To perform the cabin air flush, an existing HVAC system in the vehicle may be controlled to run for a set amount of time. The set amount of time may be determined based on an estimated decrease in odor, germs, or particulates in the air or a targeted number of air cycles. The next ride may then be scheduled to account for the time needed to perform the cabin air flush.

This technology herein may allow for a more pleasant and sanitary ride an autonomous vehicle for passengers and/or goods. Odors and germs may be more effectively removed in between rides where there is no driver to add further contaminants while traveling to the pickup location of a next ride. A fleet of autonomous vehicles may be managed such that there is little to no interruption of service to users in an area.

### Example Systems

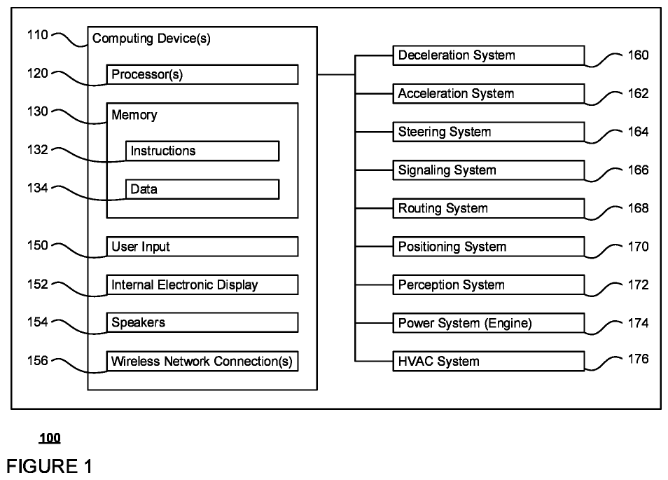

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. As an example, data 134 of memory 130 may store predefined scenarios. A given scenario may identify a set of scenario requirements including a type of object, a range of locations of the object relative to the vehicle, as well as other factors such as whether the autonomous vehicle is able to maneuver around the object, whether the object is using a turn signal, the condition of a traffic light relevant to the current location of the object, whether the object is approaching a stop sign, etc. The requirements may include discrete values, such as “right turn signal is on” or “in a right turn only lane”, or ranges of values such as “having a heading that is oriented at an angle that is 30 to 60 degrees offset from a current path of vehicle 100.” In some examples, the predetermined scenarios may include similar information for multiple objects.

The one or more processor 120 may be any conventional processor, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. As an example, internal electronic display 152 may be controlled by a dedicated computing device having its own processor or central processing unit (CPU), memory, etc. which may interface with the computing device 110 via a high-bandwidth or other network connection. In some examples, this computing device may be a user interface computing device which can communicate with a user's client device. Similarly, the memory may be a hard drive or other storage media located in a housing different from that of computing device 110. Accordingly, references to a processor or computing device will be understood to include references to a collection of processors or computing devices or memories that may or may not operate in parallel.

Computing device 110 may include all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio-visual experiences. In this regard, internal electronic display 152 may be located within a cabin of vehicle 100 and may be used by computing device 110 to provide information to passengers within the vehicle 100. In addition to internal speakers, the one or more speakers 154 may include external speakers that are arranged at various locations on the vehicle in order to provide audible notifications to objects external to the vehicle 100. The vehicle also may include one or more wireless network connections 156 configured to communicate wirelessly over a network to remote computing devices.

In one example, computing device 110 may be an autonomous driving computing system incorporated into vehicle 100. The autonomous driving computing system may be capable of communicating with various components of the vehicle. For example, returning to FIG. 1, computing device 110 may be in communication with various self-driving systems of vehicle 100, such as deceleration system 160 (for controlling braking of the vehicle), acceleration system 162 (for controlling acceleration of the vehicle), steering system 164 (for controlling the orientation of the wheels and direction of the vehicle), signaling system 166 (for controlling turn signals), navigation system 168 (for navigating the vehicle to a location or around objects), positioning system 170 (for determining the position of the vehicle), perception system 172 (for detecting objects in the vehicle's environment), and power system 174 (for example, a battery and/or gas or diesel powered engine) in order to control the movement, speed, etc. of vehicle 100 in accordance with the instructions 132 of memory 130 in an autonomous driving mode which does not require or need continuous or periodic input from a passenger of the vehicle. Again, although these systems are shown as external to computing device 110, in actuality, these systems may also be incorporated into computing device 110, again as an autonomous driving computing system for controlling vehicle 100.

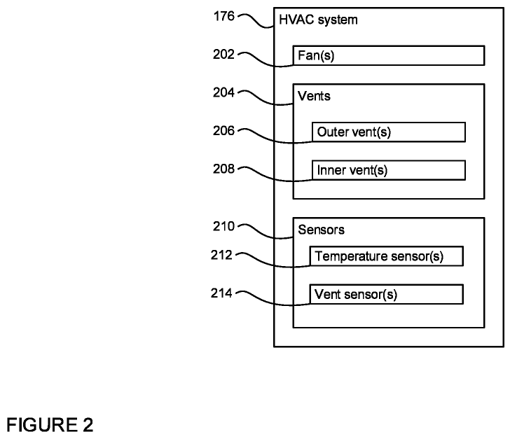

The autonomous driving computing system may also be capable of communicating with various cabin systems of the vehicle 100, such as a heating, ventilation, and air conditioning (HVAC) system 176 (for controlling temperature and ventilation in the cabin), lighting system (for controlling brightness in the cabin), seat control systems (for controlling position and recline of a seat in the cabin), or other systems. In particular, FIG. 2 shows a functional diagram of different components of the HVAC system 176. As shown, the HVAC system 176 includes one or more fans 202 that are configured to move air through a cabin of the vehicle 100, vents 204 configured to block or allow air coming in from outside the vehicle or going into the cabin of the vehicle, and sensors 210 configured to detect a state of air in the cabin and of the HVAC components. The one or more fans 202 may include a floor-level fan positioned to move air closer to the floor of the cabin and a head-level fan positioned to move air closer to the head of a passenger in the cabin. The vents 204 may include outer vents 206 between the outside of the vehicle and the HVAC system 176 and inner vents 208 between the HVAC system 176 and the cabin of the vehicle. The vents 204 may also include one or more filters, such as an active charcoal filter, a HEPA filter, and/or an ionic filter. The active charcoal filter may be capable of reducing odor; the HEPA filter may be capable of filtering particles up to 0.3 microns; and the ionic filter may be capable of ionizing particles in the air and attracting the ionized particles to the filter. The sensors may include one or more temperature sensors 212 for detecting a temperature of the air in the cabin and a temperature of air outside of the vehicle, as well as one or more vent sensors 214 configured to detect whether each of the vents 204 is open or closed. In some implementations, the HVAC system 176 may have physical and/or hardwired settings for a default or automatic state for maintaining a set interior cabin temperature.

The computing device 110 may control the direction and speed of the vehicle by controlling various components. By way of example, computing device 110 may navigate the vehicle to a destination location completely autonomously using data from the map information and navigation system 168. Computer 110 may use the positioning system 170 to determine the vehicle's location and perception system 172 to detect and respond to objects when needed to reach the location safely. In order to do so, computer 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the deceleration system 160 and acceleration system 162 may be a part of a drivetrain that includes various components between an engine of the vehicle and the wheels of the vehicle. Again, by controlling these systems, computer 110 may also control the drivetrain of the vehicle in order to maneuver the vehicle autonomously.

As an example, computing device 110 may interact with deceleration system 160 and acceleration system 162 in order to control the speed of the vehicle. Similarly, steering system 164 may be used by computing device 110 in order to control the direction of vehicle 100. For example, if vehicle 100 is configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 134 may store map information, e.g., highly detailed maps that computing devices 110 can use to navigate or control the vehicle. As an example, these maps may identify the shape and elevation of roadways, lane markers, intersections, crosswalks, speed limits, traffic signal lights, buildings, signs, real time traffic information, vegetation, or other such objects and information. The lane markers may include features such as solid or broken double or single lane lines, solid or broken lane lines, reflectors, etc. A given lane may be associated with left and right lane lines or other lane markers that define the boundary of the lane. Thus, most lanes may be bounded by a left edge of one lane line and a right edge of another lane line.

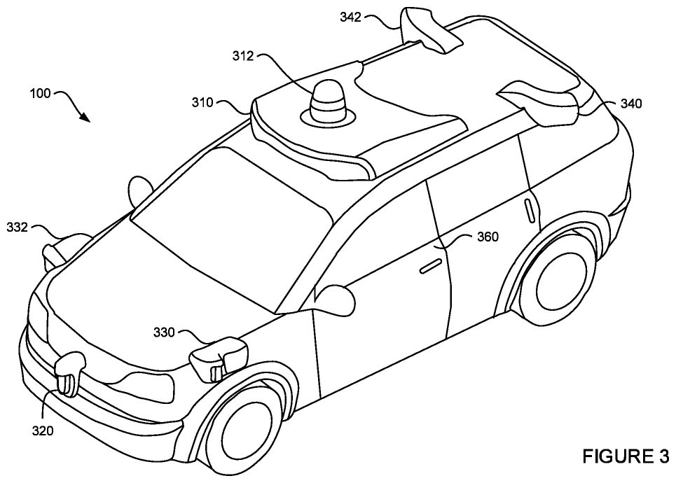

FIG. 3 is an example external view of vehicle 100 including aspects of the perception system 172. For instance, roof-top housing 310 and dome housing 312 may include a LIDAR sensor or system as well as various cameras and radar units. In addition, housing 320 located at the front end of vehicle 100 and housings 330, 332 on the driver's and passenger's sides of the vehicle may each store a LIDAR sensor or system. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

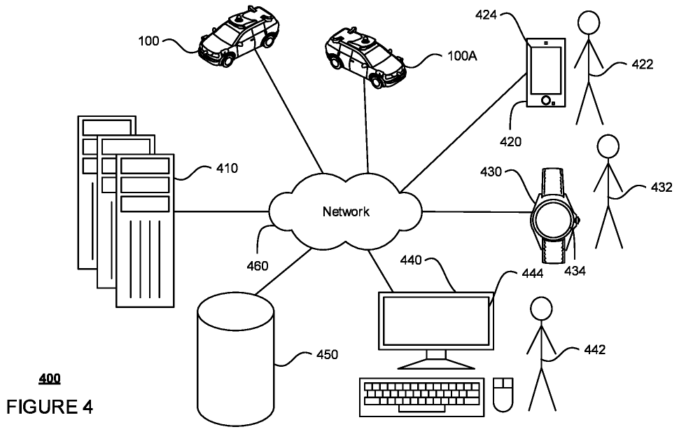

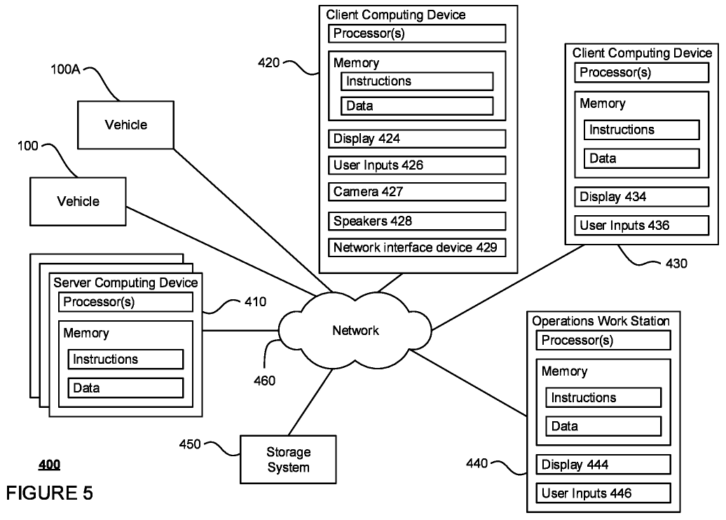

The one or more computing devices 110 of vehicle 100 may also receive or transfer information to and from other computing devices. FIGS. 4 and 5 are pictorial and functional diagrams, respectively, of an example system 400 that includes a plurality of computing devices 410, 420, 430, 440 and a storage system 450 connected via a network 460. System 400 also includes vehicle 100, and vehicle 100A which may be configured similarly to vehicle 100. Although only a few vehicles and computing devices are depicted for simplicity, a typical system may include significantly more.

As shown in FIG. 4, each of computing devices 410, 420, 430, 440 may include one or more processors, memory, data and instructions. Such processors, memories, data and instructions may be configured similarly to one or more processors 120, memory 130, instructions 132, and data 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include a server having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with one or more computing devices 110 of vehicle 100 or a similar computing device of vehicle 100A as well as client computing devices 420, 430, 440 via the network 460. For example, vehicles 100 and 100A may be a part of a fleet of vehicles that can be dispatched by server computing devices to various locations. In this example, the server computing devices may be a fleet management system for a plurality of autonomous vehicles that may direct or schedule rides for vehicles in a fleet, such as vehicles 100, 100A. The fleet management system may store in a local or remote memory program to schedule rides for each of the vehicles in the fleet based on ride requests received from a client computing device. In this regard, the vehicles of the fleet may periodically send the server computing devices location information provided by the vehicle's respective positioning systems and the one or more server computing devices may track the locations of the vehicles.

In addition, server computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 5, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touch-screen or microphone). Some of the client computing devices, such as client computing device 420, may also include a camera 427 for capturing images or recording video streams, speakers 428, a network interface device 429, and all of the components used for connecting these elements to one another.

Although the client computing devices 420, 430, and 440 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a head-mounted computing system in FIG. 5. As an example, the user may input information using a small keyboard, a keypad, microphone, using visual signals with a camera, or a touch screen.

In some examples, client computing device 440 may be a concierge workstation used to provide concierge services to users such as users 422 and 432. For example, a concierge 442 may use the concierge workstation 440 to communicate via a telephone call or audio connection with users through their respective client computing devices or vehicles 100 or 100A in order to ensure the safe operation of vehicles 100 and 100A and the safety of the users. Although only a single concierge workstation 440 is shown in FIGS. 4 and 5, any number of such workstations may be included in a typical system.

Storage system 450 may store various types of information as described in more detail below. This information may be retrieved or otherwise accessed by a server computing device, such as one or more server computing devices 410, in order to perform some or all of the features described herein. For example, the information may include user account information such as credentials (e.g., a user name and password as in the case of a traditional single-factor authentication as well as other types of credentials typically used in multi-factor authentications such as random identifiers, biometrics, etc.) that can be used to identify a user to the one or more server computing devices. The user account information may also include personal information such as the user's name, contact information, identifying information of the user's client computing device (or devices if multiple devices are used with the same user account), as well as one or more unique signals for the user.

The storage system 450 may also store routing data for generating and evaluating routes between locations. For example, the routing information may be used to estimate how long it would take a vehicle at a first location to reach a second location. In this regard, the routing information may include map information, not necessarily as particular as the detailed map information described above, but including roads, as well as information about those roads such as direction (one-way, two-way, etc.), orientation (North, South, etc.), speed limits, as well as traffic information identifying expected traffic conditions, etc.

The storage system 450 may also store information which can be provided to client computing devices for display to a user. For instance, the storage system 450 may store predetermined distance information for determining an area at which a vehicle is likely to stop for a given pickup or destination location. The storage system 450 may also store graphics, icons, and other items which may be displayed to a user as discussed below.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIG. 4 and/or may be directly connected to or incorporated into any of the computing devices 110, 410, 420, 430, 440, etc.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

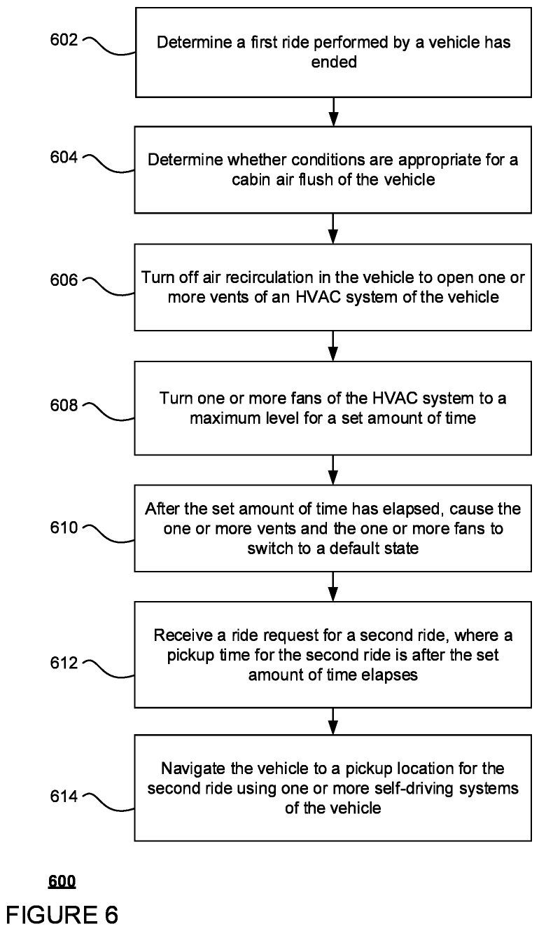

FIG. 6 is an example flow diagram 600 including a method for performing a cabin air flush in a vehicle, which includes cycling air through the vehicle, in accordance with some of the aspects described above. The method may be performed by the one or more computing devices 110 of the vehicle. Alternatively, one or more of the steps in the example method may be performed by one or more computing devices remote from the vehicle 100, such as server computing devices 410. While FIG. 6 shows blocks in a particular order, the order may be varied and that multiple operations may be performed simultaneously. Also, operations may be added or omitted.

At block 602, the vehicle's computing devices 110 may then determine that a first ride performed by a vehicle has ended. Determining the ride has ended may include detecting whether a passenger and/or good from the first ride is no longer in the vehicle 100 and/or detecting that doors and windows are open or closed. In some implementations, the vehicle's computing devices 110 may cause the doors and windows to close after detecting that the passenger and/or good from the first ride is no longer in the vehicle 100. The detection of the closure of windows or doors may be based on an indication received from a concierge workstation 440. For example, the concierge 442 or other rider support agent may view the cabin via an interior camera of the vehicle 100, visually confirm that the cabin is empty, and send the indication using the concierge workstation 440. In other implementations, the vehicle's computing devices 110 may receive an indication of the completed ride from a client device based on a location of the client device 420 relative to the vehicle or based on user input confirming that the ride is completed. Alternatively, the vehicle's computing devices 110 may detect that the passenger and/or good from the first ride is no longer in the vehicle 100 using one or more sensors in the interior of the vehicle 100, such as a camera or pressure sensor, or one or more sensors on a portion of the windows or doors that indicate a position of the relative windows or doors.

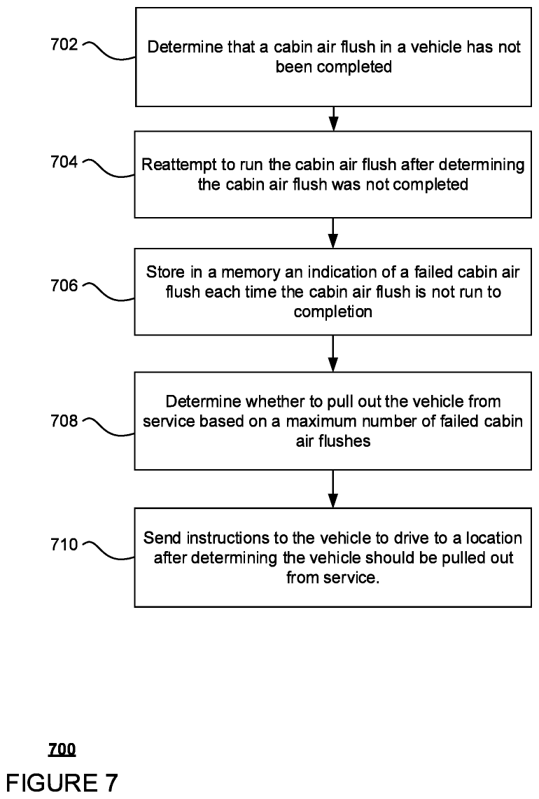

At block 604, the vehicle's computing devices 110 may determine whether conditions are appropriate for a cabin air flush of the vehicle. For example, the conditions may include temperature constraints for operation of the HVAC system 176 and/or the vehicle 100. In particular, for optimal operation of the HVAC system 176, an external maximum temperature may be set at which point the cabin air flush may be canceled. The conditions may also include other technical limitations related to how the HVAC system 176, such as checking whether components of the HVAC system 176 for the cabin air flush, such as the vents or the fans, are in working order. When the conditions are not met for the cabin air flush, the process may continue to block 702 of FIG. 7. When the conditions are appropriate for the cabin air flush, the process may continue to block 606.

At block 606, the vehicle's computing devices 110 may turn off air recirculation in the vehicle 100, if it is not already off, to open one or more vents of the HVAC system 176 of the vehicle. The vehicle's computing devices 110 may determine that the air recirculation is on based on an indicator or based on one or more sensors detecting that a vent for air recirculation is closed. When the air recirculation is determined to be on, the vehicle's computing devices 110 may cause the vent for the air recirculation to open and allow air from outside to flow through the vehicle 100.

At block 608, the vehicle's computing devices 110 may turn one or more fans of the HVAC system 176 to a maximum level for a set amount of time, thereby performing the cabin air flush. The maximum level is the level at which the one or more fans are moving a most amount of air through the cabin. The maximum level may include the maximum possible fan speed for the one or more fans. In addition, the maximum level may include turning on the one or more fans that are positioned to move the most amount of air through the cabin, such as both floor-level fans and head-level fans. A direction of the one or more fans may be taken into account to streamline the movement of the most amount of air through the cabin. For example, the one or more fans may be configured to move air in a same or similar direction. The maximum level may also include a set temperature, such as 70 degrees Fahrenheit, so the cabin temperature is kept or changed to a comfortable temperature during the cabin air flush. In some cases, the maximum level may also include turning air conditioning off during the cabin air flush. Turning air conditioning off may be included based on vehicle-specific constraints for fresh air intake, such as only being configured to open an air vent for fresh air intake 100% if the air conditioning is off.

The set amount of time may be predetermined based on a size of the vehicle's cabin and the amount of air that is moved by the HVAC system 176 over time when operating at a maximum level. The amount of air to be moved by the HVAC system 176 may be determined based on how much an odor or particular particulates in the air decreases as air is moved through the cabin. For example, the amount of air to be moved may be determined to meet particular air sanitation measurements, such as reducing germ concentration by 99% or more, or to reduce a particular type of odor, such as odor caused by food or waste, by a particular amount to reach a target amount. In some implementations, the set amount of time may correspond to how long it takes for the HVAC system 176 to perform a target number of air cycles in the cabin. For example, the set amount of time may correspond to how long it takes for the HVAC system 176 to move an amount of air that corresponds to 4.6 times the volume of air in the cabin, or in other words, to perform 4.6 air cycles through the cabin. Performing 4.6 air cycles may sanitize the air in the cabin by 99% or more or less. In this particular implementation, the set amount of time may be 6 minutes to perform 4.6 air cycles through the vehicle's cabin. In other examples, the set amount of time may correspond to moving an amount more or less than 4.6 times the volume of air in the cabin, or 4.6 air cycles. For example, the set amount of time may be 2 minutes to correspond to a reduction in odor after the source of an odor is no longer in the cabin.

Alternatively, the amount of time for the cabin air flush may be variable based on feedback regarding a state of the air in the cabin, or air quality in the cabin. The feedback regarding air quality may include an amount of detected odor or an amount of detected particulates in the air of the cabin, which may be detected by sensors 210. Prior to performing the cabin air flush, the vehicle's computing devices 110 may determine a state of the air in the cabin, such as an amount of odor or particulates, detected by the sensors 210 and estimate an amount of time and/or other additional settings for the cabin air flush to reach a target air quality, such as reducing the amount of odor or particulates to a target amount. In other implementations, the vehicle's computing devices 110 may track the amount of odor or particulates detected by the sensors 210 as the one or more fans are running. The vehicle's computing devices 110 may determine an end to the amount of time for the cabin air flush when the tracked amount of odor or particulates reaches a target amount.

At block 610, after the set amount of time has elapsed, the vehicle's computing devices 110 may cause the one or more vents and the one or more fans to switch into a default state. The default state may be a previous state that the one or more vents and the one or more fans of HVAC system 176 were operating in prior to the cabin air flush or a preferred state for a user that will be using the vehicle 100 for the next ride. The default state may alternatively be defined by a target default temperature, such as 70 degrees Fahrenheit or more or less, and automatic settings in the vehicle 100 for reaching and maintaining the target default temperature. In some cases, switching into a default state may include changing only one of a vent or a fan in the HVAC system 176.

At block 612, the vehicle's computing devices may receive a ride request for a second ride, where a pickup time for the second ride is after the set amount of time elapses. The ride request may be received before, during, or after the set amount of time. At block 614, the vehicle's computing devices may navigate the vehicle 100 to a pickup location for the second ride using one or more self-driving systems of the vehicle 100. The navigation of the vehicle to the pickup location for the second ride may occur before, during, or after the set amount of time. If the vehicle 100 reaches the pickup location before the set amount of time elapses, the vehicle's computing devices 110 may not unlock or open a door of the vehicle 100 to load a passenger or good for the second ride until the set amount of time elapses. In an alternative implementation, the vehicle's computing devices 110 may end the cabin air flush early, such as when the door of the vehicle is opened or just prior to the door of the vehicle is opened. Alternatively, the vehicle's computing devices 110 may time the arrival of the vehicle 100 at the pickup location to be after the set amount of time elapses by controlling the speed and/or route of the vehicle.

In some implementations, a notification may be displayed in the vehicle 100 or sent to a client device, such as client device 420 of user 422, indicating that the air cabin flush has been completed in the vehicle after the previous ride and before the ride requested by the user.

FIG. 7 shows an example flow diagram 700 in accordance with aspects of the disclosure. More specifically, FIG. 7 shows a flow of an example method for responding to a failed cabin air flush performed by the vehicle's computing devices 110. Alternatively, one or more of the steps in the example method may be performed by one or more computing devices remote from the vehicle 100, such as server computing devices 410. While FIG. 7 shows blocks in a particular order, the order may be varied and that multiple operations may be performed simultaneously. Also, operations may be added or omitted.

At block 702, the vehicle's computing devices 110 may determine that the cabin air flush in the vehicle has not been completed. Time stamps may be used to track when the cabin air flush is not started, started, interrupted, or completed. This determination may be based on when conditions for the cabin air flush have not been met, such as described in block 604. Alternatively, the determination may be based on when there is a lack of information related to the conditions for the cabin air flush. The determination may additionally or alternatively be based on a manual override received from a driver, concierge workstation, or fleet management system 440. The determination may additionally or alternatively be based on whether settings for the cabin air flush meet the odor elimination requirements or air sanitation requirements. For example, a power of the one or more fans during the cabin air flush may not reach the intended maximum level, which means that the amount of air cycled through the vehicle during the set amount of time may not meet the target amount of air. In some implementations, one or more reasons for the failure to complete the cabin air flush may be determined. The one or more reasons may correspond to the basis of the determination of the failure, such as unmet conditions, lack of information, manual override, unmet accomplishments, etc.

At block 704, the vehicle's computing devices 110 may reattempt to run the cabin air flush after determining the cabin air flush was not completed. The reattempt may include blocks 606 and 608 described above. The cabin air flush may be reattempted a number of times, such as three times. In some implementations, the cabin air flush may be reattempted after the conditions for the cabin air flush have been met. In other implementations, the cabin air flush may not be reattempted in certain circumstances and therefore skip this block 704, such as when a manual override is received or a second ride with a passenger or good is started.

At block 706, the vehicle's computing devices 110 may store in a memory an indication of a failed cabin air flush each time the cabin air flush is not run to completion. The cabin air flush may be determined as having not run to completion when the cabin air flush is interrupted, such as by a manual override, or when the number of reattempts have been exhausted. In implementations where the one or more reasons for the failure to complete the cabin air flush is determined, the one or more reasons may also be stored with the indication of the corresponding failed cabin air flush. The memory may be a local memory 130 or a remote memory, such as storage system 450. After a cabin air flush is successfully completed, the indications may be cleared from the memory. When the number of indications reach a maximum number between completed cabin air flushes, the vehicle's computing devices 110 may send a message to the server computing devices 410 that the maximum number of failed cabin air flushes. The maximum number may be three, or more or less. The message may include an identifier for the vehicle 100, a link to a page for details about the vehicle 100, or one or more causes of the failed cabin air flush(es). The one or more causes may include a request timeout, manual override, or a HVAC system failure.

At block 708, the server computing devices 410 may determine whether to pull out the vehicle 100 from service based on the maximum number of failed cabin air flushes. In some implementations, the vehicle 100 may be pulled out from service just on the basis of the occurrence of the maximum number of failed cabin air flushes. In other implementations, other factors may be part of the determination, such as, for example, whether a future time is possible for another cabin air flush, whether components of the vehicle 100 require maintenance or repair in order to perform a cabin air flush, or whether enough time is possible to allow for odor reduction or air sanitation prior to a second ride. The determination to pull out the vehicle 100 from service may additionally or alternatively be based on the type of cause of the failed cabin air flush(es). When the one or more causes indicate a systemic error, such as an HVAC system failure or a consistent program bug, the server computing devices 410 may determine to pull out the vehicle 100 from service. In contrast, when the one or more causes are temporary or may otherwise be fixed/avoided, the server computing devices 410 may determine not to pull out the vehicle 100 from service.

At block 710, the server computing devices 410 may send instructions to vehicle 100 to drive to a location after determining the vehicle 100 should be pulled out from service. For example, the instructions may be for the vehicle 100 to be examined or repaired. The location may be a maintenance depot when components of the vehicle 100 require maintenance or repair, or when a manual cleaning is determined to be necessary. The location may alternatively be a parking or storage area for the vehicle 100 to remain until a program solution may be developed and installed. The instructions may include a scheduled time to drive to the location.

In some implementations, the server computing devices 410 may further determine whether to ground an entire fleet of autonomous vehicles when a threshold number of vehicles in the fleet have had a maximum number of failed cabin air flushes, as described in block 706. The threshold number may be ten vehicles, or more or less, or may be a percentage of the fleet, such as 10%, or more or less. In some scenarios, the server computing devices 410 may determine to ground the fleet based on the type of cause of the failed cabin air flushes, such as whether the type of cause is a systemic error, a consistent program bug, or a temporary cause as described above for block 708. To ground the entire fleet, the server computing devices 410 may send instructions to every vehicle in the fleet to travel to a maintenance depot or other location to be examined or repaired. The server computing devices 410 may also send a message to client devices in the service area of the fleet to inform them of the service outage and/or provide alternatives.

Alternatively, the vehicle's computing devices 110 may determine whether to pull out the vehicle 100 from service and drive the vehicle 100 to a location in a same or similar way as described for blocks 708 or 710.

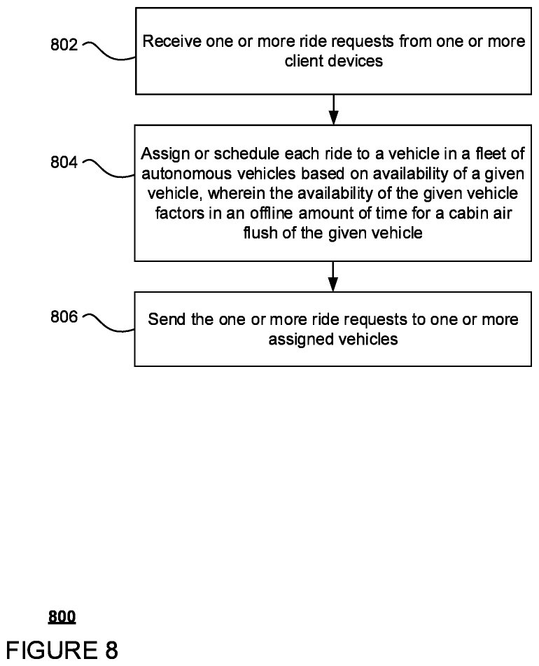

FIG. 8 shows an example flow diagram 800 in accordance with aspects of the disclosure. More specifically, FIG. 8 shows a flow of an example method for scheduling rides for an autonomous vehicle based on the air cabin flush performed by a fleet management system, such as server computing devices 410. Alternatively, one or more of the steps in the example method may be performed by the vehicle's computing devices 110. While FIG. 8 shows blocks in a particular order, the order may be varied and that multiple operations may be performed simultaneously. Also, operations may be added or omitted.

At block 802, the server computing devices 410 may receive one or more ride requests from one or more client devices. At block 804, the server computing devices 410 may assign or schedule each ride to a vehicle in a fleet of autonomous vehicles based on availability of a given vehicle. The availability of a given vehicle may factor in an offline amount of time for the air cabin flush, as described above in FIG. 6. For example, the offline amount of time may be 6 minutes after the first ride is completed, or whatever amount of time is determined to perform the needed amount of air cycles. Alternatively, the offline amount of time may include the amount of time for the air cycles plus additional buffer time. In particular, the server computing devices 410 may not assign a given vehicle any rides that occur within the offline amount of time or may schedule a second ride after the offline amount of time. At block 806, the server computing devices 410 may send the one or more ride requests to one or more assigned vehicles. When a ride request is received, the computing devices of a given assigned vehicle may perform the requested ride at a scheduled point in time.

In some implementations, settings for the cabin of the autonomous vehicle may be configured or changed using a remote system. Settings for the cabin may include which fans are on or off, fan speed, air temperature, length of cabin air flush, or other cabin air flush settings. One or more computing devices remote from the vehicle 100, such as server computing devices 410 or client computing devices 420, 430, may send instructions for the settings to the autonomous vehicle via a network, such as network 460.

This technology herein may allow for a more pleasant and sanitary ride an autonomous vehicle for passengers and/or goods. Odors, germs, or particulates may be more effectively removed in between rides where there is no driver to add further contaminants while traveling to the pickup location of a next ride. A fleet of autonomous vehicles may be managed such that there is little to no interruption of service to users in an area.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A control system for an autonomous vehicle, the control system comprising:
one or more computing devices in communication with a heating, ventilation, and air conditioning (HVAC) system, the one or more computing devices being configured to:
determine a first ride performed by the autonomous vehicle has ended;
turn off air recirculation in a cabin of the autonomous vehicle to open one or more vents of the HVAC system of the vehicle;
turn one or more fans of the HVAC system to a maximum level for a set amount of time for a cabin air flush; and
after the set amount of time has elapsed, cause the one or more vents and the one or more fans to switch to a default state.

2. The control system of claim 1, wherein the one or more computing devices are further configured to determine that conditions are appropriate for the cabin air flush.

3. The control system of claim 1, wherein the set amount of time is defined based on cabin size of the autonomous vehicle and a target number of air cycles

4. The control system of claim 1, wherein the set amount of time is variable based on a state of air in the cabin of the autonomous vehicle.

5. The control system of claim 1, wherein the maximum level for the one or more fans includes a set fan speed to move a most amount of air through the cabin and a set temperature for air in the cabin.

6. The control system of claim 1, wherein the one or more computing devices are further configured to:
determine that the cabin air flush in the vehicle has not been completed;
reattempt to run the cabin air flush after determining the cabin air flush was not completed; and
store in a memory an indication of a failed cabin air flush each time the cabin air flush is not run to completion.

7. The control system of claim 6, wherein the one or more computing devices are further configured to send a message to a remote system when a maximum number of failed cabin air flushes are stored in the memory.

8. The control system of claim 6, wherein the one or more computing devices are further configured to:
determine whether to pull the autonomous vehicle from service based on a maximum number of failed cabin air flushes stored in the memory; and
cause the autonomous vehicle to drive to a location for going out of service after determining the vehicle should be pulled out from service.

9. The control system of claim 1, wherein the one or more computing devices are further configured to receive settings for the cabin air flush from a remote computing device, the settings including at least the set amount of time for the cabin air flush.

10. A method for running a cabin air flush in a vehicle, the method comprising:
determining, by one or more computing devices, a first ride performed by the vehicle has ended;
turning off, by the one or more computing devices, air recirculation in a cabin of the vehicle to open one or more vents of an HVAC system of the vehicle;
turning, by the one or more computing devices, one or more fans of the HVAC system to a maximum level for a set amount of time for the cabin air flush; and
after the set amount of time has elapsed, causing, by the one or more computing devices, the one or more vents and the one or more fans to switch to a default state.

11. The method of claim 10, wherein the turning of the one or more fans to the maximum level for the set amount of time is based on cabin size of the vehicle and a target number of air cycles.

12. The method of claim 10, wherein the turning of the one or more fans to the maximum level for the set amount of time is setting a fan speed to move a most amount of air through the cabin and a set temperature for air in the cabin.

13. The method of claim 10, further comprising receiving, by the one or more computing devices, a ride request for a second ride, the second ride having a pickup time that is after the set amount of time elapses.

14. The method of claim 10, further comprising:
determining, by the one or more computing devices, that the cabin air flush in the vehicle has not been completed;
reattempting, by the one or more computing devices, to run the cabin air flush after determining the cabin air flush was not completed; and
storing in a memory, by the one or more computing devices, an indication of a failed cabin air flush each time the cabin air flush is not run to completion.

15. The method of claim 14, further comprising sending, by the one or more computing devices, a message to a remote system when a maximum number of failed cabin air flushes are stored in the memory.

16. The method of claim 14, further comprising:
determining, by the one or more computing devices, whether to pull the vehicle from service based on a maximum number of failed cabin air flushes stored in the memory; and
causing, by the one or more computing devices, the vehicle to drive to a location for going out of service after determining the vehicle should be pulled out from service.

17. A tangible, non-transitory computer-readable storage medium configured to store instructions, the instructions, when executed by one or more processors, cause the one or more processors to perform a method for running a cabin air flush in a vehicle, the method comprising:
determining a first ride performed by the vehicle has ended;
turning off air recirculation in a cabin of the vehicle to open one or more vents of an HVAC system of the vehicle;
turning one or more fans of the HVAC system to a maximum level for a set amount of time for the cabin air flush; and
after the set amount of time has elapsed, causing the one or more vents and the one or more fans to switch to a default state.

18. The storage medium of claim 17, wherein the turning of the one or more fans to the maximum level for the set amount of time is based on cabin size of the vehicle and a target number of air cycles.

19. The storage medium of claim 17, wherein the turning of the one or more fans to the maximum level for the set amount of time is setting a fan speed to move a most amount of air through the cabin and a set temperature for air in the cabin.

20. The storage medium of claim 17, wherein the method further comprises:
determining that the cabin air flush in the vehicle has not been completed;
reattempting to run the cabin air flush after determining the cabin air flush was not completed; and
storing in a memory an indication of a failed cabin air flush each time the cabin air flush is not run to completion.
